(19) United States
(12) Patent Application Publication
(10) Pub. No.: US 2020/0377136 A1
(43) Pub. Date: Dec. 3, 2020

(54) Child Pushchair

(71) Applicant: Mima International Ltd., Hong Kong (CN)

(72) Inventors: David Kho, Bangkok (TH); Alvaro Jimenez, Valencia (ES)

(21) Appl. No.: 16/332,426

(22) PCT Filed: Sep. 11, 2017
(86) PCT No.: PCT/IB2017/001264

§ 371 Date: Mar. 12, 2019

(30) Foreign Application Priority Data
Sep. 12, 2016 (DE) 102016010884.3

(51) Int. Cl. B62B 7/08

(52) U.S. Cl. CPC B62B 7/08; B62B 2205/20; B62B 2205/26

(57) ABSTRACT

The present invention relates to a fold-up child pushchair of the buggy type with a back frame (1), a seat frame (2) connected to the latter in an articulated manner by means of a first articulated axis and a lower rear frame (3) connected to the seat frame in an articulated manner by means of a second articulated axis, further comprising at least one support strut (4), which is connected to the back frame (1) so as to swivel about a third articulated axis when the buggy is folded up and is connected in an articulated manner in a second region to the lower rear frame (3) so as to swivel about a fourth articulated axis, wherein the seat frame (2) has a, proceeding from the first articulated axis, continuous roughly U-shaped upwardly open U-strut, as viewed in the front view of the buggy, wherein according to the invention the U-strut of the seat frame (2), as viewed in the side view of the buggy, has a course, proceeding from the first articulated axis, angled off downwards towards the front wheels (7). A form of the strut of the seat frame that is more fittingly geared to the seating position of the child is thus obtained. The mechanism for disengaging the articulated joints for the purpose of folding up the buggy can comprise at least one pull handle (5, 6) or pull grip, which is arranged in the region of the seat frame (2).

### CROSS REFERENCE TO RELATED APPLICATIONS

This application is the U.S. national stage of International Application No. PCT/162017/001264, filed on 2017 Sep. 11. The international application claims the priority of DE 102016010884.3 filed on 2016 Sep. 12; all applications are incorporated by reference herein in their entirety.

### BACKGROUND

The present invention relates to a fold-up child pushchair of the buggy type with a framework comprising a back frame, a lower front seat frame connected to the latter in an articulated manner, wherein, when the buggy is folded up, the back frame swivels with respect to the lower front seat frame about a first common articulated axis, further comprising a lower rear frame connected in an articulated manner to the lower front seat frame, wherein, when the buggy is folded up, the lower rear frame swivels with respect to the lower front seat frame about a second common articulated axis, further comprising at least one support strut, which on the one hand is connected in a first region in an articulated manner to the back frame so as to swivel about a third articulated axis when the buggy is folded up, wherein the support strut on the other hand is connected in an articulated manner in a second region, at a distance from the first region, to the lower rear frame so as to swivel about a fourth articulated axis, wherein the seat frame has a, proceeding from the first articulated axis, continuous roughly U-shaped upwardly open U-strut, as viewed in the front view of the buggy.

Child pushchairs of the buggy type are characterised in that the child therein is pushed in a sitting or semi-recumbent position, that they are comparatively easy to push and suitable for all terrain and that they can be folded up from the basic position (mobile position) into a transport position, in which they are folded up in a space-saving manner and can easily be transported. The most diverse designs of such buggies with different mechanisms for the folding-up into the transport position are known from the prior art. Many buggies are folded in such a way that the upper part, i.e. the back frame or push frame, swivels backwards in the direction of the rear wheels. In the case of other models, the folding-up takes place in the reverse direction, so that the upper part of the frame (back frame) is folded forwards in the direction of the front wheels.

In WO 2010/143301 A1, a buggy is described, wherein the back frame is constituted as a roughly U-shaped hoop with an articulated axis at the lower end, in order to swivel the back frame when the folding-up takes place, wherein however the lower framework comprises a central body, from which two struts extend diagonally forwards in a roughly pyramid-shaped arrangement, at the ends whereof the front wheels are located, and struts also extend diagonally backwards to the rear wheels, so that, when the folding-up takes place, not only do the front wheels move towards the rear wheels, but also the two front wheels and the rear wheels move inwards towards one another. The four struts of the lower framework thus move as it were in a scissor-like manner towards one another and are provided with guide rods for this purpose. Such a folding mechanism is very expensive in design and comprises many connection elements.

In WO 2012/034940 A1, a buggy with the features mentioned at the outset is described, wherein the framework has a comparatively simple structure with comparatively few frame parts connected to one another in an articulated manner. The back frame comprises a U-strut and is connected in an articulated manner to a lower front frame, which also comprises an roughly U-shaped strut, which is open to the top, wherein however these two frame parts in the articulation region are aligned with one another and the lower front frame part runs downwardly inclined in a straight line, so that it basically does not specify a seating position, but rather a corresponding seating element is suspended in the frame for this purpose. The shape of the framework specifies here a position of the child lying in an inclined plane. The release of the articulated joints for the purpose of folding-up the buggy takes place in this case as with most other buggies of this type also via the articulated joints themselves, for example by the latter being pushed inwards.

### SUMMARY

The present invention relates to a fold-up child pushchair of the buggy type with a back frame (1), a seat frame (2) connected to the latter in an articulated manner by means of a first articulated axis and a lower rear frame (3) connected to the seat frame in an articulated manner by means of a second articulated axis, further comprising at least one support strut (4), which is connected to the back frame (1) so as to swivel about a third articulated axis when the buggy is folded up and is connected in an articulated manner in a second region to the lower rear frame (3) so as to swivel about a fourth articulated axis, wherein the seat frame (2) has a, proceeding from the first articulated axis, continuous roughly U-shaped upwardly open U-strut, as viewed in the front view of the buggy, wherein according to the invention the U-strut of the seat frame (2), as viewed in the side view of the buggy, has a course, proceeding from the first articulated axis, angled off downwards towards the front wheels (7). A form of the strut of the seat frame that is more fittingly geared to the seating position of the child is thus obtained. The mechanism for disengaging the articulated joints for the purpose of folding up the buggy can comprise at least one pull handle (5, 6) or pull grip, which is arranged in the region of the seat frame (2).

### DETAILED DESCRIPTION

The problem of the invention consists in providing an alternative fold-up child pushchair of the buggy type of the generic class mentioned at the outset, which specifies a more sitting position of the child in the region of the frame, whilst retaining a simple structure in terms of design with only a few frame parts and a simple mechanism for folding up the buggy into the transport position.

The solution to this problem is provided by a fold-up child pushchair of the buggy type of the generic class mentioned in the outset with the characterising features of claim 1.

According to the invention, provision is made such that the U-strut of the seat frame, as viewed in the side view of the buggy, has a course, proceeding from the first articulated axis, angled downwards towards the front wheels. By means of this solution, a form of the strut of the seat frame that is more fittingly geared to the seating position of the child is obtained. Moreover, another relative position of the articulated axes to one another results, which changes somewhat the kinematics of the swivelling movement when the buggy is folded up.

According to a preferred development of the invention, the U-strut of the seat frame has an obtuse-angled to roughly right-angled course, as a result of which an adaptation to the seat shape results. The advantage of a continuous, in the front view roughly U-shaped strut for the seat frame is retained, so that the design of the framework is achieved with few components and the production and assembly of such a buggy is simplified.

According to the development of the invention, provision is preferably made such that the front wheels are located on the lower front seat frame and the rear wheels are located on the lower rear frame. Such a solution is easier in terms of production than the use of separate struts to the wheels, which have to be fastened to a further component. Moreover, the design according to the invention is mechanically more robust. For example, the two front wheels can be fitted on both sides of the lower vertex to the U-strut.

According to a development of the invention, the U-strut of the seat frame in the basic position (mobile position) of the buggy, as viewed in the side view, preferably comprises, proceeding from the first articulated axis, a first roughly horizontal or slightly ascending section, which extends to the obtuse-angled or roughly right-angled bend, which is then followed, towards the front wheels, by a second section inclined downwards.

The effect of this embodiment of the seat frame, when the second articulated axis is preferably arranged in the first section of the U-strut of the seat frame, is that the second articulated axis then lies, in the basic position of the buggy viewed in the side view of the buggy, above the first articulated axis or roughly at the same level as the latter. This leads to different geometrical conditions in the swivelling movement when the buggy is folded up than in the case of the solutions known from the prior art, since there the first articulated axis as a rule always lies above the second articulated axis.

A preferred development of the invention makes provision such that the lower rear frame comprises at least two U-struts connected to one another, i.e. a lower U-strut in the form of an upwardly open U, on which the rear wheels are located, and an upper roughly U-shaped strut in the form of an upwardly open U, wherein the lower and upper U-strut, as viewed in the front view, are connected to one another roughly in the region of their respective vertex points. A roughly X-shaped basic form for the rear frame thus results, with the provision that the vertices of the two struts do not run rectilinearly, but are each rounded off into a U-shape.

According to a preferred development of the solution to the problem according to the invention, the two upper end regions of the U-strut of the rear frame, which essentially have the shape of an upwardly open U, are each linked on the outside to the seat frame. This has the advantage, for example, that the upper regions of the strut of the rear frame do not interfere in the seat region and the full width of the seat region between the two struts of the U-shaped seat frame is available there.

The U-strut of the lower rear frame is preferably fitted with its two upper end regions in the first section of the U-strut of the seat frame, in an articulated manner to the latter. The second articulated axis is thus located relatively close to the first articulated axis and lies at least approximately at the same height as the latter, which has an influence on the kinematics in the swivelling movement of the frame parts of the buggy during the folding-up.

According to a development of the invention, the two upper end regions of the U-strut of the rear frame, viewed in the front view, are each bent over or angled off somewhat inwards and towards one another, i.e. the rear frame is somewhat wider than the seat frame beneath the seat area.

Furthermore, the two upper end regions of the U-strut of the rear frame, viewed in the side view, are preferably each bent over or angled off somewhat backwards in the direction of the back frame. The second articulated joint can thus lie relatively close to the first articulated joint, without however the struts of the rear frame and those of the back frame hindering one another during the swivelling movement.

Furthermore, it is the problem of the present invention to provide a fold-up child pushchair of the buggy type with the features of the generic class mentioned at the outset, which has a reliable mechanism easy to operate for the engagement of the articulated joints for the folding-up. The solution to this problem emerges from the fact that the mechanism for the release of the articulated joints comprises at least one pull lever or pull grip, which is arranged in the region of the seat frame. This manner of disengagement for releasing the articulated joints before the folding-up proves to be particularly ergonomic and convenient compared to known solutions, in which the disengagement takes place in the articulated joints themselves.

According to a development of the invention, the mechanism for the disengagement of the articulated joints preferably comprises a first pull lever or pull grip, after the pulling-out of which the buggy can be folded up by the exertion of a pulling force on a second pull lever or pull grip. These two pull levers or pull grips can be positioned in such a way that they lie close beside one another and the operation is then very simple. For example, the operating person releases the engagement of the articulated joint with one hand using the first pull lever and then pulls the second pull lever, as a result of which the buggy can then as it were be lifted and the of the folding-up movement into the transport position takes place.

The features mentioned in the sub-claims relate to preferred developments of the solution to the problem according to the invention. Further advantages of the invention emerge from the following detailed description.

### BRIEF DESCRIPTION OF THE DRAWINGS

The present invention is described in greater detail below with the aid of examples of embodiment making reference to the appended drawings.

In the figures:

FIG. 1 shows a perspective front view of an exemplary buggy according to the invention;

FIG. 2 shows a simplified side view of the buggy from FIG. 1 in a partial longitudinal section:

FIG. 3 shows a perspective exploded representation of the main parts of a buggy according to the invention;

FIG. 4 shows a side view of the buggy according to the example of embodiment of FIGS. 1 to 3 in the basic position;

FIG. 5 shows a corresponding side view of the buggy from FIG. 4 in a partially folded-up position;

FIG. 6 shows a further side view of the buggy from FIG. 5 in the completely folded-up transport position.

### DETAILED DESCRIPTION OF THE PREFERRED EMBODIMENTS

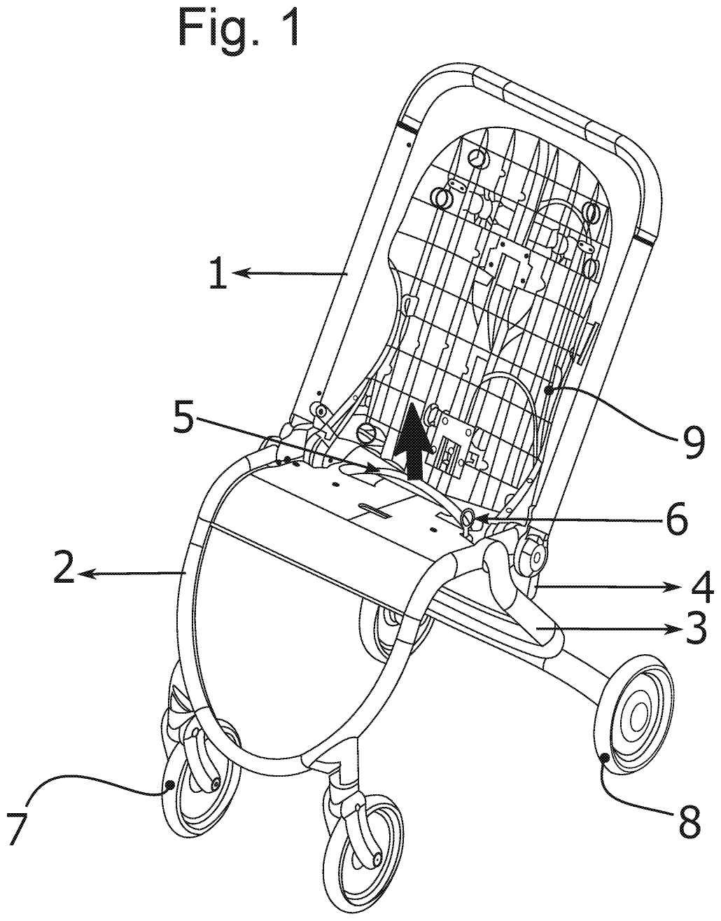

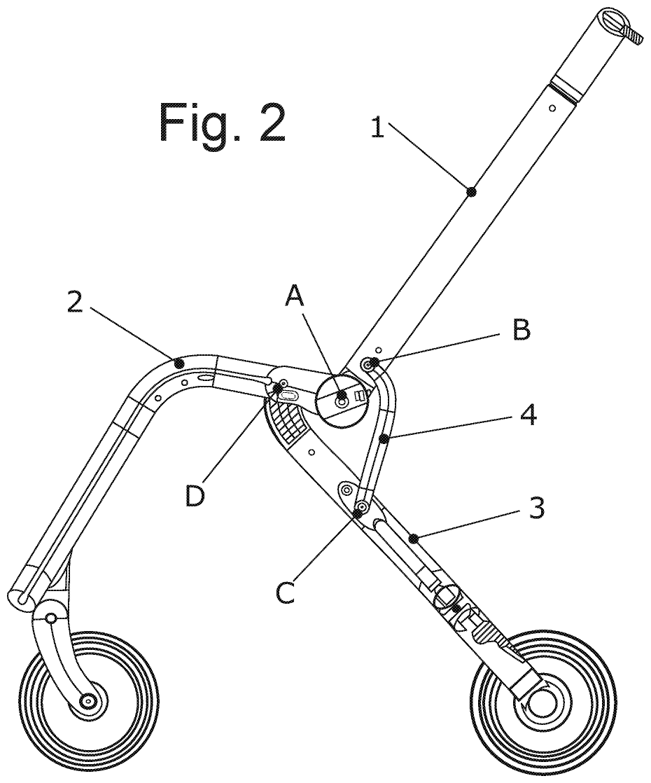

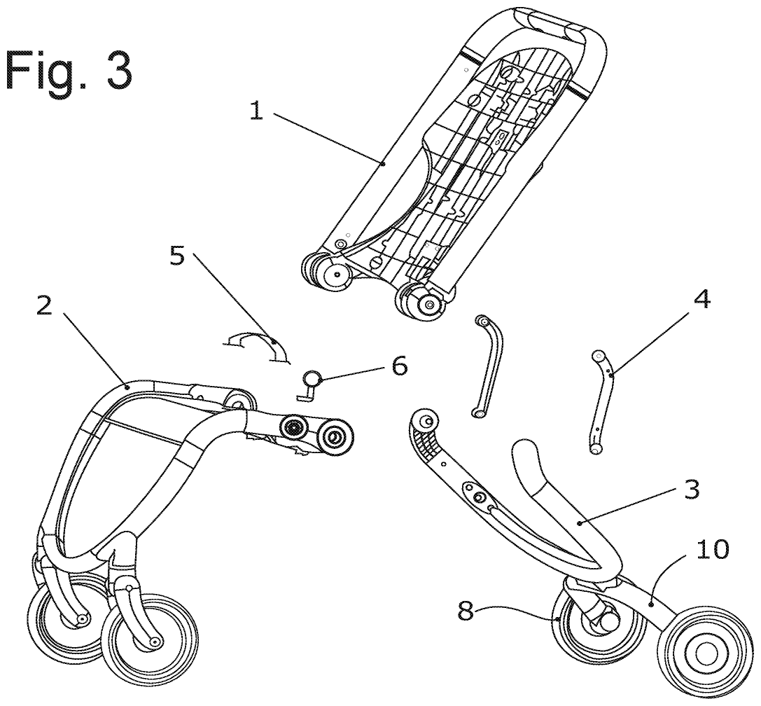

Reference is first made below to FIGS. 1 to 3 and the basic structure of a buggy according to the invention is described with the aid thereof. The latter comprises a back frame 1, which basically consists of a roughly U-shaped strut in the form of a downwardly open U, as can be seen particularly well in FIG. 3. Inserted into this U-shaped strut 1 is a flat back part 9, which serves to support the back and for example has a grid-like structure comprising longitudinal and transverse struts or wires, wherein the precise embodiment of this flat back part does not enter into the scope of the present invention. The articulated joint is located on both sides at the lower end of the U-shaped strut of back frame 1, about the articulated axis whereof, running perpendicular to the legs of the strut, the back frame swivels when the buggy is folded up. This articulated axis is the first articulated axis within the meaning of the present invention, which is denoted by A in FIG. 2.

Furthermore, the buggy comprises a seat frame 2, which comprises a U-shaped strut bent on itself in the form of an upwardly open U, wherein this seat frame 2 is connected to back frame 1 so as to be swivellable in the two upper end regions of the U-strut via the aforementioned articulated joint of first articulated axis A. In the lower region, the two front wheels 7 of the buggy are located on both sides in each case outside the vertex point of the U on the strut of seat frame 2. As can clearly be seen in the side view according to FIG. 2, the U-strut of seat frame 2, viewed from the side, runs from front wheels 7 extending in a shape bent at a blunt angle, which replicates the form of a seat. The angle of the bend amounts for example to approximately 110 to 120°. The course of the U-strut of seat frame 2 is preferably such that the vertex of the bend lies somewhat higher than the end connected to back frame 1, at which the first articulated axis with rotation point A is located. At some distance before this rotation point A, seat frame 2 is connected to a lower rear frame 3 so as to be swivellable about a second articulated axis, the shape of which lower rear frame can be seen particularly well in the exploded representation according to FIG. 3. In its upper region, this rear frame 3 comprises a U-strut in the shape of an upwardly open U. This is in turn connected at the underside to a second somewhat shorter U-strut 10, which has the shape of a downwardly open U, and the two rear wheels 8 of the buggy are fitted to the two ends of this lower strut.

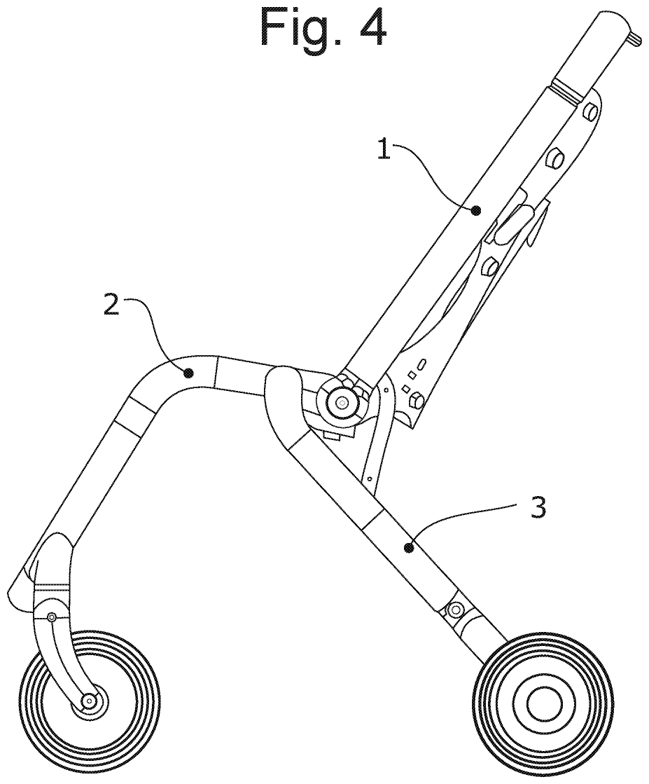

As can be seen in FIGS. 1 and 3, the shape of the U-strut of rear frame 3 is furthermore such that, viewed in the front view, a bend of the strut inwards results in each case at the upper ends of the legs of the U. Accordingly, the articulated connection of the strut of rear frame 3 to the strut of seat frame 2 is such that seat frame 2 lies inside rear frame 3 and is enclosed by the latter. The second swivel axis, about which seat frame 2 and rear frame 3 mutually swivel when the buggy is folded up, corresponds to rotation point D shown in FIG. 2. In the side view according to FIG. 4, it can be seen that the two struts of rear frame 3 are bent over at their upper ends in each case somewhat backwards in the direction of first articulated axis A.

The frame of the buggy according to the invention thus essentially comprises three larger frame parts as can be seen in particular in FIG. 3, which are connected to one another in an articulated manner, i.e. back frame 1, seat frame 2 and rear frame 3. The frame construction of the buggy further comprises two support struts 4 which, as emerges from FIG. 2, are connected to back frame 1 at their upper ends in each case in an articulated manner by means of a third articulated axis at rotation point B and which are connected to rear frame 3 in each case at their lower end by means of a fourth articulated axis at rotation point C. An articulated-joint quadrangle thus results with the first articulated axis at rotation point A, the second articulated axis at rotation point D, the third articulated axis at rotation point B and the fourth articulated axis at rotation point C. These four articulated axes determine the swivelling movement of the buggy when it is folded up. As can be seen in FIG. 2, the first articulated axis at rotation point A is located at a lower position than the two adjacent articulated axes at rotation points D and B and the articulated-joint rectangle formed from the four articulated axes has a concave corner, i.e. it is a concave rectangle.

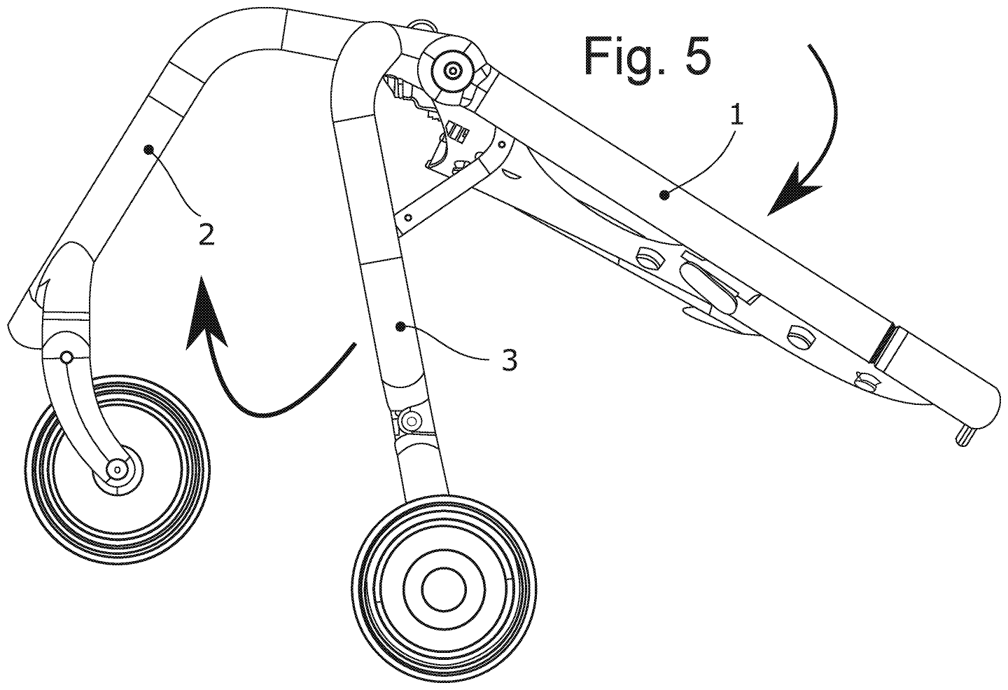

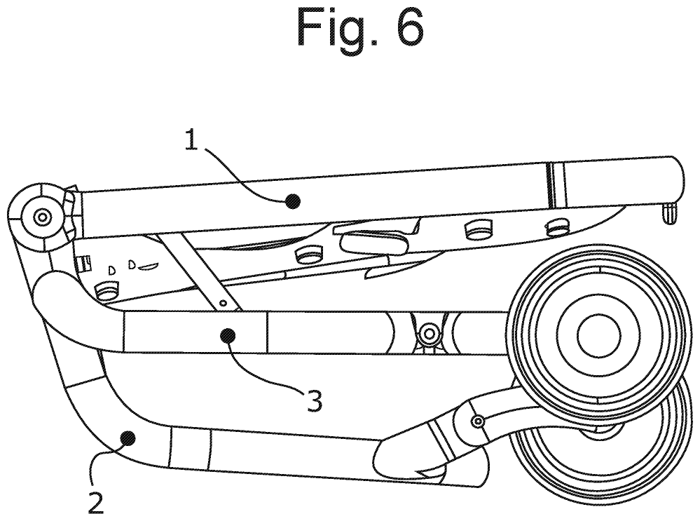

The movement sequence in the swivelling movement during folding-up of the buggy is explained below proceeding from the basic position shown in FIG. 4 (mobile position) into the folded-up transport position (see FIG. 6) by reference to FIGS. 4 to 6. Reference is also made to FIG. 2, in which the four rotation points of the articulated axes are indicated. FIG. 5 shows the buggy in a partially folded-up state. Proceeding from FIG. 4, back frame 1 is swivelled backwards in the direction of the rear wheels of the buggy. In comparison of FIGS. 4 and 5, it can be seen that the distance between back frame 1 and rear frame 3 is shortened, whereas at the same time the angle between back frame 1 and seat frame 2 increases during folding-up, wherein back frame 1 swivels, in a clockwise direction in the drawing, in the direction of the arrow shown in FIG. 5.

Back frame 1 swivels about rotation point A of the first articulated axis with respect to seat frame 2. Support struts 4, which on the one hand are linked to back frame 1 and on the other hand to rear frame 3, force rear frame 3 to swivel likewise in the clockwise direction, as a result of which its angular distance from seat frame 2 is shortened, as can be seen by the arrow also shown in FIG. 5. Rear frame 3 thus swivels with respect to seat frame 2 about the second articulated axis of rotation point D. The upper end of support struts 4 swivels about the third articulated axis at rotation point B with respect to back frame 1 and the lower end of support struts 4 swivels about the fourth articulated axis at rotation point C with respect to rear frame 3. FIG. 5 shows a partially folded-up middle position, whereas FIG. 6 shows the completely finally folded-up transport position. As can be seen, the strut of back frame 1, the strut of rear frame 3 and also the strut of seat frame 2 lie comparatively close beside one another and in an almost parallel position, so that a compact transport position results.

The mechanism for disengagement the articulated joints so that the buggy can be folded up is explained in greater detail below by reference to FIG. 1. A first pull lever denoted by 6 can be seen there, which when pulled out can release a mechanism in the articulated joints at rotation point A, which blocks the latter in the basic position. This mechanism can comprise for example components engaging into one another such as teeth of toothed wheels or suchlike and is not explained in greater detail here. After this first pull lever 6 has been pulled, the articulated joints can be released by lifting a strap-like second pull lever 5 which is broader in the example, so that the buggy can be folded up into the transport direction. First pull lever 6 thus serves as it were as a safety device and only when the latter has been released is second pull lever 5 effective at all. This thus prevents the articulated joints undesirably being released and the folding-up movement being triggered due to inadvertent lifting of second pull lever 5. Second pull lever 5, which is constituted strap-like and which can thus be gripped from below by hand engages at its two ends at two points, which then release, for example by pull means not explained in detail here, the articulated joints which connect back frame 1 and seat frame 2 together. This second pull lever has the further advantage that, by lifting the same, on the one hand the articulated joints can be released and simultaneously the buggy can also be lifted, so that the folding-up can be assisted by the inherent weight of the buggy. It is thus possible, for example, with one hand to lift this second pull lever 5 (see also the arrow in FIG. 1) and with the other hand, by gripping back frame 1 for example in the upper region, to assist the folding-up movement until the transport position represented in FIG. 6 is reached.

### LIST OF REFERENCE NUMERALS

1 back frame
2 seat frame
3 rear frame
4 support struts
5 second pull lever
6 first pull lever
7 front wheels
8 rear wheels
9 back part
10 lower U-strut
A rotation point, first articulated axis
D rotation point, second articulated axis
B rotation point, third articulated axis
C rotation point, fourth articulated axis

1. A fold-up child pushchair of the buggy type with a framework comprising a back frame (1), a lower front seat frame (2) connected to the latter in an articulated manner, wherein, when the buggy is folded up, the back frame (1) swivels with respect to the lower front seat frame about a first common articulated axis (A), further comprising a lower rear frame (3) connected in an articulated manner to the lower front seat frame (2), wherein, when the buggy is folded up, the lower rear frame (3) swivels with respect to the lower front seat frame (2) about a second common articulated axis (D), further comprising at least one support strut (4), which on the one hand is connected in a first region in an articulated manner to the back frame (1) so as to swivel about a third articulated axis (B) when the buggy is folded up, wherein the support strut (4) on the other hand is connected in an articulated manner in a second region, at a distance from the first region, to the lower rear frame (3) so as to swivel about a fourth articulated axis (C), wherein the seat frame (2) has a, proceeding from the first articulated axis (A), continuous roughly U-shaped upwardly open U-strut, as viewed in the front view of the buggy, characterised in that the U-strut of the seat frame (2), as viewed in the side view of the buggy, has a course, proceeding from the first articulated axis (A), angled downwards towards the front wheels (7).

2. The fold-up child pushchair according to claim 1, characterised in that the U-strut of the seat frame (2) has an obtuse-angled to roughly right-angled course.

3. The fold-up child pushchair according to claim 1, characterised in that the two front wheels (7) are fitted on both sides of the lower vertex to the U-strut of the seat frame (2).

4. The fold-up child pushchair according to claim 1, characterised in that the U-strut of the seat frame (2) in the basic position (mobile position) of the buggy, as viewed in the side view, comprises, proceeding from the first articulated axis (A), a first roughly horizontal or slightly ascending section, which extends to the obtuse-angled or roughly right-angled bend, which is then followed, towards the front wheels (7), by a second section inclined downwards.

5. The fold-up child pushchair according to claim 4, characterised in that the second articulated axis (D) is arranged in the first section of the U-strut of the seat frame (2).

6. The fold-up child pushchair according to claim 1, characterised in that the second articulated axis (D) lies, in the basic position of the buggy viewed in the side view of the buggy, above the first articulated axis (A) or roughly at the same level as the latter.

7. The fold-up child pushchair according to claim 1, characterised in that the lower rear frame (3) comprises at least two U-struts connected to one another, i.e. a lower U-strut (10) in the form of an upwardly open U, on which the rear wheels (8) are located, and an upper roughly U-shaped strut in the form of an upwardly open U, wherein the lower and upper U-strut, as viewed in the front view, are connected to one another roughly in the region of their respective vertex points.

8. The fold-up child pushchair according to claim 1, characterised in that the lower rear frame (3) comprises at least one U-strut roughly in the form of an upwardly open U, the two upper end regions whereof are linked in each case at the outside to the seat frame (2).

9. The fold-up child pushchair according to claim 8, characterised in that the U-strut of the lower rear frame (3) is fitted with its two upper end regions in the first section of the U-strut of the seat frame (2).

10. The fold-up child pushchair according to claim 8, characterised in that the two upper end regions of the U-strut of the rear frame (3), viewed in the front view, are each bent over or angled off somewhat inwards and towards one another.

11. The fold-up child pushchair according to claim 8, characterised in that the two upper end regions of the U-strut of the rear frame (3), viewed in the side view, are each bent over or angled off somewhat backwards in the direction of the back frame (1).

12. The fold-up child pushchair according to claim 1, characterised in that the front wheels (7) are located on the lower front seat frame (2) and the rear wheels (8) are located on the lower rear frame (3).

13. A fold-up child pushchair of the buggy type with a framework comprising a back frame (1), a lower front seat frame (2) connected to the latter in an articulated manner, wherein, when the buggy is folded up, the back frame (1) swivels with respect to the lower front seat frame about a first common articulated axis (A), further comprising a lower rear frame (3) connected in an articulated manner to the lower front seat frame (2), wherein, when the buggy is folded up, the lower rear frame (3) swivels with respect to the lower front seat frame (2) about a second common articulated axis (D), further comprising at least one support strut (4), which on the one hand is connected in a first region in an articulated manner to the back frame (1) so as to swivel about a third articulated axis (B) when the buggy is folded up, wherein the support strut (4) on the other hand is connected in an articulated manner in a second region, at a distance from the first region, to the lower rear frame (3) so as to swivel about a fourth articulated axis (C), wherein the seat frame (2) has a, proceeding from the first articulated axis (A), continuous roughly U-shaped upwardly open U-strut, as viewed in the front view of the buggy, characterised in that the mechanism for the disengagement of the articulated joints comprises at least one pull lever (5, 6) or pull grip, which is arranged in the region of the seat frame.

14. The fold-up child pushchair according to claim 13, characterised in that the mechanism for the disengagement of the articulated joints comprises a first pull lever (6) or pull grip, after the pulling-out of which the buggy can be folded up by the exertion of a pulling force on a second pull lever (5) or pull grip of the buggy.

15. The fold-up child pushchair according to claim 13, characterised in that, by the pulling-out of the second pull lever (5) and/or the first pull lever (6) or pull grip, engagement or locking elements which lock the articulated joints, which connect the back frame (1) to the seat frame (2) in a manner so as to be swivellable about the first articulated axis (A), are released.

16. The fold-up child pushchair according to claim 1, characterised in that the mechanism for the disengagement of the articulated joints comprises at least one pull lever (5, 6) or pull grip, which is arranged in the region of the seat frame.
